(19) United States
(12) Patent Application Publication
(10) Pub. No.: US 2008/0279472 A1
(43) Pub. Date: Nov. 13, 2008

(54) Noise Reduction in a Digital Image by Discreter Cosine Transform

(76) Inventor: Pascal Hannequin, Menthon Saint Bernard (FR)

Correspondence Address: WILLIAM H. EILBERG, 316 CALIFORNIA AVE. #785, RENO, NV, 89509, US

(21) Appl. No.: 12/093,345

(22) PCT Filed: Nov. 15, 2006
(86) PCT No.: PCT/FR06/02523

§ 371 Date: May 12, 2008

(30) Foreign Application Priority Data
Nov. 18, 2005 (FR) 0512103

(51) Int. Cl. G06K 9/40

(52) U.S. Cl. 382/260

(57) ABSTRACT

A digitized image obtained by sensing noisy radiations is processed in a central unit. The image is considered to be an array of pixel intensity values that is decomposed into p elementary arrays of n pixels which are then ordered into a processing array with p rows and n columns. A discrete cosine transform is applied to this array so as to deduce the n significant factors. A reconstructed processing array is then reconstructed by taking account of the most significant functions, and from this is deduced a reconstituted image in which the high-frequency noise is reduced, preserving satisfactory contrast.

### TECHNICAL FIELD OF THE INVENTION

The present invention concerns methods and devices for filtering digitized images, in particular methods and devices for eliminating noise in a digitized image.

Certain images suffer greatly from noise, which reduces their legibility. Such is the case, for example, of images obtained from low-level signals, in which the wanted signals are strongly disturbed by interferences and other physical phenomena that degrade the transmission of the signals.

Such is also the case of certain medical imaging images, such as scintigraphy images.

In nuclear medicine, the scintigraphy technique consists in injecting patients with biological molecules marked by gamma-emitting radioactive isotopes. Gamma photons are detected with the aid of a gamma camera.

Gamma photons are emitted at random by the emitting particles injected into the human body. The signals captured depend, on the one hand, on the quantity of emissive particles in a given area and, on the other hand, on the random nature of the emission of each particle. In a scintigraphy image, which is an image of the distribution of the gamma photons coming from an organism, each image element or pixel is an integer number that is the number of particles, i.e. the number of photons, detected in front of it. It is found that these integer values are distributed around a mean value in accordance with Poisson's law.

The distribution of Poisson's law conforms to the formula:

$$Pr ( X = k ) = \frac{{μ}^{k} {e}^{- μ}}{k !}$$

Pr (X=k) is the probability that the pixel X will take the value k. μ is the mean value of the distribution.

FIG. 1 gives an example of a distribution in accordance with Poisson's law for a mean value μ=5.

Another case of a distribution in accordance with Poisson's law is the distribution of X photons such as those used in tomodensitometry (X-ray scanner), which consists in visualizing the anatomical structures of an organism using the different attenuations of X-rays by biological tissues.

In all cases, the images are affected by Poissonian noise, resulting from the random character of emissions, and the relative magnitude of this noise is inversely proportional to the number of events detected. This is because the relative error of the measurement is given by the formula:

Relative error=[(variance)(X)]^{1/2}/mean(X)=√μ/μ=1/√μ

The relative error therefore varies in inverse proportion to the number of events detected.

To improve the legibility of an image, it is therefore natural to reduce the noise, and for this to increase the number of events detected.

A first way to do this is to acquire the images over a longer time period. However, this may be difficult if the subject moves, for example in radiology because of respiratory and cardiac movements. Moreover, the increase in the acquisition time immobilizes the detection equipment for longer, which causes serious scheduling problems in the field of medical imaging.

A second way to increase the number of photons detected is to increase the flux of particles. In medical imaging, this implies increasing the radioactive dose injected or the flux of X photons. However, this will commensurately increase the dose of radiation received by the patient, which goes against the principles of radioprotection.

Finally, using more efficient detection devices might be envisaged, but this immediately causes cost problems.

To illustrate the influence of the increase in the number of photons detected on the quality of the image, FIG. 2 reproduces an image of a digital phantom consisting of lines (top left). Based on this, three scintigraphy acquisitions have been simulated by adding Poissonian noise. The image top right corresponds to a mean number of strikes of 30 (high noise). The image bottom left corresponds to a mean number of strikes of 60 (moderate noise). The image bottom right corresponds to a mean number of strikes of 120 (low noise). The quality of this last image is very much better.

Clearly Poissonian noise consists in a random variation between a pixel and the adjacent pixels, which variation is not linked to the real difference in the concentration of emissive particles between the area in front of the pixel concerned and the areas in front of the adjacent pixels. It is therefore high-frequency noise, i.e. it introduces sudden variations from one pixel to another in the series of pixels of an image.

As it is often very difficult to increase the number of photons detected, the invention proposes to reduce the high-frequency noise contained in an image by the use of a particular filtering device.

Filtering images with the aim of reducing the influence of noise has already been proposed. Very many filters have been proposed.

The simplest and best known filter replaces the value of each pixel by the mean of the values of the adjacent pixels. A Gaussian filter has also been proposed, which gives a Gaussian spatial distribution weight to the different adjacent pixels and replaces the central pixel by a linear combination of the adjacent pixels.

One example is described in the document WO 01/72032, which defines particular filter coefficients preserving a certain contrast of the image, where possible.

The above document also states the problem of all filters, whether weighted or not: all these filters improve the signal/noise ratio, but at the cost of a strongly degraded spatial resolution and contrast of the image. Clearly a filter effecting a weighted mean between several adjacent pixels necessarily reduces the sudden variations of intensity between the adjacent pixels, and therefore reduces contrast effects.

By way of example, FIG. 3 shows the processing of a digital phantom image affected by noise (the moderate noise level bottom left in FIG. 2) by two filters: the top left view is the unfiltered raw image; the top right view is the image filtered by a 3×3 weighted filter; the bottom left view is the image filtered by a 3×3 median filter, which replaces each pixel by the median of the adjacent pixels. It is seen that the contours are not very clear in the filtered images, following a reduction in the spatial resolution and contrast.

Filtering images by multivariate statistical analysis methods applied to a table of numbers each expressing the degree of brightness of a corresponding pixel in the digitized image has also been proposed.

Thus the document XP 002212651 AEBERSOLD, STADELMANN, ROUVIERE describes processing electronic microscope images. This processing is effected by means of a factorial analysis of correspondences applied to a table consisting of the pixels of the digitized image. The analysis is applied to the entire digitized image, seeking in that entire image the correspondence factors most representative of the image, i.e. those corresponding to the highest eigenvalues, then reconstructing the image from only those representative factors. Although in theory the method achieves good quality filtering of a given image, in practice it does not adapt the filtering to the structure of the image to be filtered, and so results remain disappointing.

The document XP 001074312 HANNEQUIN, LIEHN, VALEYRE proposes to apply factorial analysis of correspondences to a series of entire scintigraphy images, and suggests using the likelihood ratio test to determine the correspondence factors to be used to reconstruct the series of images. The method is again applied to the whole of the images. The result of filtering is slightly improved, but remains disappointing for certain image structures to be filtered.

The same problems are encountered in the documents XP 008007773 and XP 008007666, which apply statistical processings to the whole of an image.

In the document WO 03/050760, the inventor has more recently proposed to filter an image by applying factorial analysis of correspondences (FAC) separately to adjacent portions of the image. This has substantially improved the resolution of the filtered image (FIG. 3, bottom right image), but at the cost of an increase in the quantity and duration of computation.

The image is still degraded in the high-resolution image portions, i.e. in the bottom right and top left portions of each image, as can be seen by comparing the images not affected by noise (top left in FIG. 2) and after FAC filtering (bottom right in FIG. 3).

There is still a need for a more effective and faster filter device for eliminating high-frequency noise without significantly reducing the resolution or contrast of the image.

### STATEMENT OF THE INVENTION

Thus an object of the present invention is faster and more effective filtering of images affected by Poissonian noise, such as medical imaging images, scintigraphy and tomodensitometry images, quickly producing images of improved quality, using means of particularly low cost.

Furthermore, according to the invention, this filtering is preferably adaptive, thus reducing as much as possible the loss of information resulting from filtering.

To achieve the above and other objects, the invention provides a method of processing a digitized image consisting of a table T of numbers x₍ᵢⱼ₎ each expressing the degree of brightness of a corresponding pixel of rank i, j (for example the number of particles detected in the corresponding pixel), the method comprising the reduction of high-frequency noise (for example a Poissonian statistical noise) by the following steps:

a) decomposing the table T into a continuous series of p elementary tables of the same size each having n pixels,

b) ordering the data from the series of elementary tables into a processing table X of p rows and n columns, each row i being formed of the ordered series of the pixels of the elementary table of rank i,

d) effecting on the processing table X an orthogonal transformation into the frequency space, considering the n columns as variables, to extract therefrom the n representative orthogonal functions with their associated coefficients,

f) generating a reconstituted processing table XR of numbers xr_{(i,j)} by independently reconstructing each row i taking into account only the functions having a significant weight with the row i, and re-establishing the absolute degrees of brightness, then generating a reconstituted table TR constituting the reconstituted digitized image in which high-frequency noise has therefore been reduced.

According to the invention, during the step d), a pre-established orthogonal transformation with n pre-established orthogonal coefficients is used. The orthogonal transformation takes a set of pixels from the image and transforms them into an equivalent representation in the frequency space.

The processing of the processing table X by pre-established orthogonal transformation uses prestored calculation tables that are identical regardless of the images to be filtered. It is therefore not necessary to recalculate them on each filtering operation, with the result that the calculations are faster and smaller than in a multivariate statistical analysis method such as factorial analysis of correspondences.

Thanks to row by row reconstruction, the invention adapts the filtering to each subset of the image, which significantly improves the result obtained.

In one advantageous embodiment, the method uses, in the step d), a discrete cosine transform (DCT) to calculate, for each row of the processing table X, the coefficients corresponding to the n orthogonal functions.

Preferably, during a step e), the squared cosines of the rows are calculated on the n orthogonal functions and the squared cosines are used to test the weight of the representative functions in the row i.

It is found that the discrete cosine transform further improves the quality of filtering and in particular the resolution of the filtered images obtained. The result is shown in FIG. 4, after filtering applied to the images affected by noise from FIG. 2.

In one advantageous embodiment, the invention proposes a method providing for auto-adaptative reconstruction in order to eliminate high-frequency noise as much as possible without affecting image quality. This is achieved by retaining only the variance of the signal by eliminating the variance of the noise. To this end, according to the invention, reconstruction of a row of the reconstituted table XR is stopped as soon as a sufficient number of functions has been used for the variance of the reconstructed row to be greater than the variance of the original signal from which the estimated variance of the noise has been subtracted.

The test applies particularly well to processing an image affected by Poissonian noise, for example. In this case, a property of Poisson's law is that its mean value is equal to its variance:

variance(X)=mean(X)=μ

As a result, a good estimate of the variance of the noise is obtained by calculating the mean value of the signals from line i.

Another aspect of the invention proposes a device for processing digitized images, comprising a memory, a calculation unit, an input-output device for receiving data constituting the digitized image to be processed, viewing means and/or printing means for viewing the processed image, and a program stored in memory and adapted to execute the above method.

The invention applies in particular to a medical imaging installation comprising a device of this kind.

### BRIEF DESCRIPTION OF THE DRAWINGS

Other objects, features and advantages of the present invention will emerge from the following description of particular embodiments, given with reference to the appended figures, in which:

FIG. 1 shows a Poisson distribution with mean value 5;

FIG. 2 shows the improvement of an image on increasing the duration of observation of a Poissonian phenomenon;

FIG. 3 shows the results obtained in the prior art by weighted and median filters or by factorial analysis of correspondences;

FIG. 4 shows the result that can be obtained with a filter according to one embodiment of the invention;

FIG. 5 shows the main steps of a filtering method of the present invention;

FIG. 6 shows an offsetting principle used for limiting edge effects in the method of the invention; and

FIG. 7 is a diagram showing an imaging installation incorporating an image processing device of the invention.

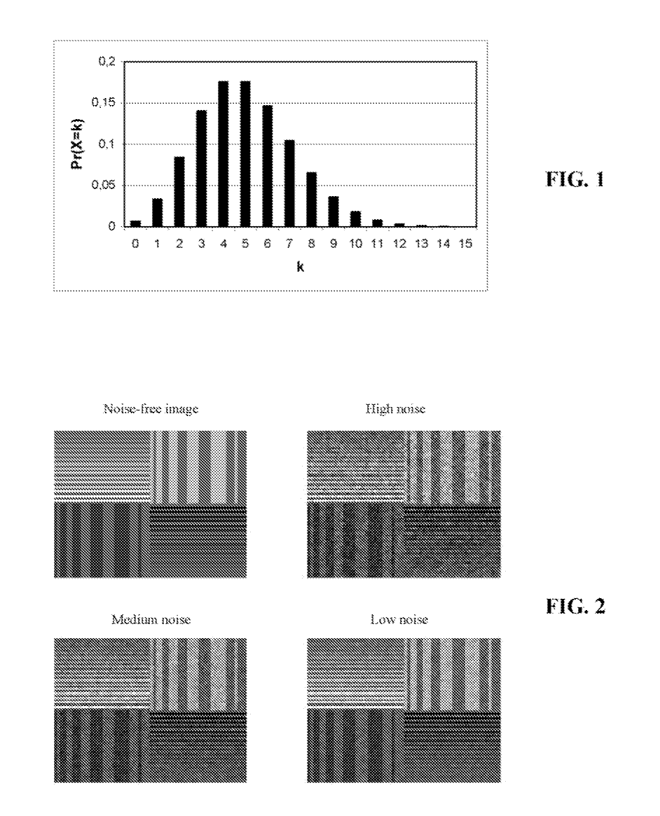

### DESCRIPTION OF PREFERRED EMBODIMENTS

Consider first FIG. 7, which shows diagrammatically a medical imaging installation comprising a gamma ray sensor 1 such as a gamma camera moving in two directions in front of a subject 2 to be observed and capturing gamma rays 3 coming from radio-emissive particles previously injected into the body of the patient 2. The gamma ray sensor 1 sends to a calculation unit 4 a series of signals imaging the photons received on each elementary area or pixel of the gamma ray sensor 1, the calculation unit 4 storing in a memory 5 the number of photons of each pixel, corresponding to the intensity of the pixel. The memory 5 therefore contains a digitized image consisting of a table T of numbers x (i, j) each expressing the number of photons detected (or the degree of brightness) of a pixel from the row i and the column j of the observed area 1. According to the invention, the installation further comprises a program stored in the memory 5 for controlling the calculation unit 4 to filter the image digitized in this way and to produce on a viewing or printing device 6 a filtered image of good quality from which high-frequency noise has been extracted.

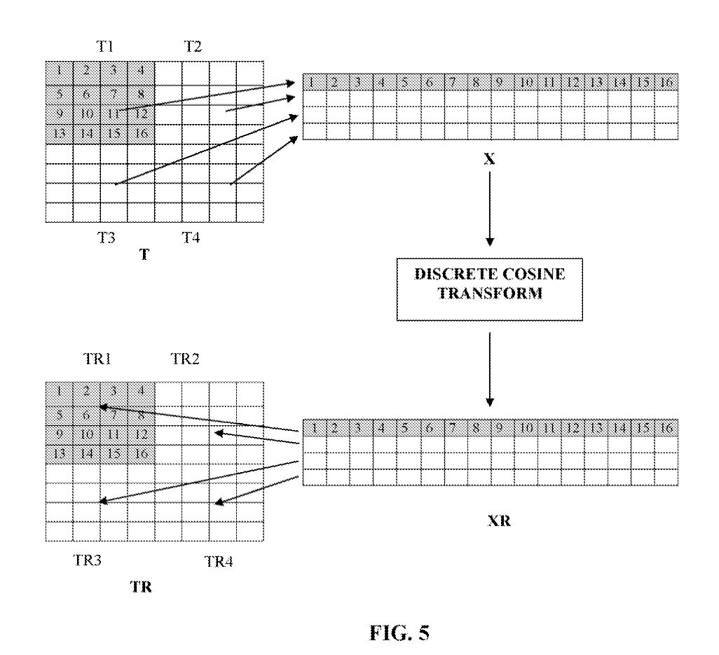

One embodiment of an image filtering method of the present invention is described next with reference to FIG. 5.

The table T constitutes the digitized image. In practice, the digitized images contain a large number of pixels. To simplify the explanation, a square image consisting of 8×8 pixels is considered here, each pixel being shown by a small square.

The first operation a) of the noise reducing method of the invention is to decompose the table T into a continuous series of p elementary tables of the same size each having n pixels, where n is a power of 2. In the example shown in FIG. 5, four elementary tables T1, T2, T3 and T4 are considered, each having 16 pixels.

Thereafter, in a step b), the data from the series of elementary tables T1-T4 is ordered into a processing table X of p rows and n columns, each row i being formed of the ordered sequence of pixels of the elementary table of rank i. Thus the first row of the table X contains the pixels 1 to 16 from the table T1, arranged in order. Likewise, the second row of the table X contains the pixels from the table T2, arranged in order, and so on. In this example, the processing table X therefore has four rows each of 16 columns.

In the FIG. 5 example, the table T has been decomposed into four square elementary tables T1-T4 each having four rows and four columns. Nevertheless, without departing from the scope of the invention, the table T could be decomposed into a series of square or rectangular tables all having the same size but in which the number of rows and/or columns differs from 4.

Thereafter, in a step c), the processing table X can be normalized, if appropriate, to obtain a normalized matrix Xn in which each element xnᵢⱼ from row i and column j is weighted by a transform using the mean of the values of the elements from the row i and the mean value of the elements from the column j.

Then, in the step d), the discrete cosine transform (DCT) is used to calculate for each row its n coefficients corresponding to the n orthogonal functions.

The following formula can be used for the discrete cosine transform (DCT) calculation:

$$T ( u , v ) = {\sum }_{x = 0}^{N - 1} {\sum }_{y = 0}^{N - 1} f ( x , y ) α ( u ) α ( v ) cos [ \frac{( 2 x + 1 ) u Π}{2 N} ] cos [ \frac{( 2 y + 1 ) v Π}{2 N} ]$$

N is the size of the elementary table

f(x,y) is the value of the pixel at the point with coordinates x and y

T(u,v) is the equivalent in the frequency space

$$\begin{matrix}α ( u ) = √ ( 1 / N ) for u = 0 \\ = √ ( 2 / N ) for u - 1 , … , N - 1\end{matrix}$$

and likewise for a(v).

The squared cosines of the p rows on the n orthogonal functions are then calculated.

During a step e), the n functions are then classified in decreasing order as a function of their respective weight.

During a step f), a reconstituted processing table XR of numbers xr (i, j) is generated using only the first q functions representative of each row.

Finally, a reconstituted table TR is generated, constituting the reconstituting digitized image, in which high-frequency noise is reduced, for example Poissonian statistical noise.

In step e), the squared cosine can be calculated using the formula:

cos²ₖ(i)=cₖ(i)cₖ(i)

in which cₖ(i) is the coefficient of the row i for the function k according to the formula:

$${c}_{k} ( i ) = {\sum }_{j = 1}^{n} {x}_{ij} \cdot fk ( j )$$

in which fk(j) is the j^{th} value of the function fk.

During the step e), the n factors can advantageously be classified as a function of their squared cosine calculated in this way.

According to the invention, the reconstituted processing table XR is reconstituted row by row, independently, taking into account only the q factors having the maximum squared cosine for the row i.

Assuming that the first q functions are taken into consideration, the reconstructed value xrᵢⱼ (q) of the element from the reconstructed processing table XR of row and column j is calculated from the formula:

$${xr}_{ij} ( q ) = {\sum }_{k = 1}^{q} {c}_{k} ( i ) fk ( j )$$

where fk(j) is the j^{th} component of the k^{th} orthogonal function.

Starting from the reconstituted processing table XR, in FIG. 5, the reconstituted table TR is reconstructed row by row, the first row of the reconstituted processing table XR constituting the pixels of the first elementary table TR1, and so on.

According to the invention, the filter device can advantageously be adapted automatically to the content of the image. This automation is effected for each area of the image corresponding to one of the elementary tables T1 to T4. To this end the reconstituted table XR is reconstructed row by row. The reconstructed values xrᵢⱼ of a row i of elements from the reconstituted table XR are calculated step by step:
the value of the elements xrᵢⱼ for increasing values q of the number of functions taken into account is calculated successively,
the residual variance Var_res(q) of the row i is calculated each time,
the residual variance is compared to the estimated variance of the noise to be reduced, and
the calculation of the row i is stopped when the residual variance of the row i is no longer statistically greater than the estimated variance of the noise from row i in the starting image, thereby obtaining a noise-free estimated final image (Im_final).

In practice, the residual variance Var_res(q) of the row i is the variance of the difference between the row i of the processing table X and the row i of the reconstituted processing table XR as reconstructed with q functions.

The test comparing the residual variance and the estimated variance of the noise can advantageously be effected by:

a) calculating the variable t from the formula

t=(Var_noise)xhi(ddl)/ddl

in which xhi (ddl) is the value given by the χ² table for a risk of 5% and a number ddl of degrees of freedom,

ddl is the number of degrees of freedom, where

ddl=n−q−1

q being the number of factors taken into account,

b) stopping the reconstruction when the residual variable Var_res(q) is less than t.

In the case where the method is applied to the processing of an image affected by noise following a Poisson law, the estimated variance of the noise of the row i is taken as equal to the mean value of the elements xᵢⱼ of the row i of the processing table X.

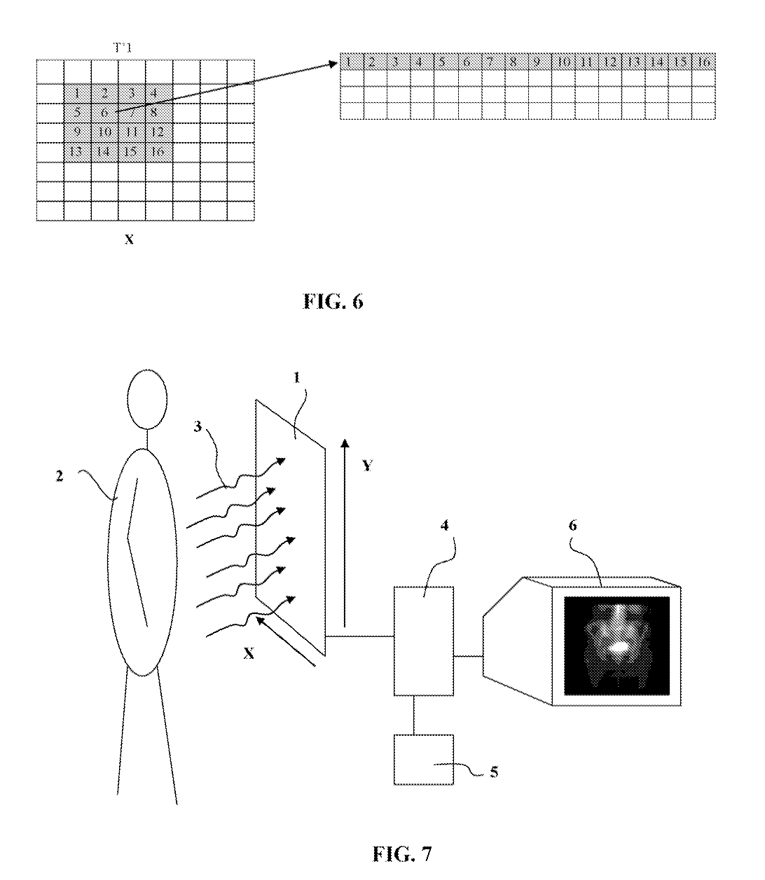

To reduce further the influence of noise on the results, and to reduce edge effects, the procedure described hereinabove can be repeated several times on the same image, offsetting the division into elementary tables by one pixel each time. FIG. 5 shows the first procedure for an offset of 0 in x and of 0 in y. FIG. 6 shows the second procedure for an offset of 1 pixel in x and 1 pixel in y: the elementary table T′1 is offset by 1 pixel to the right and by 1 pixel down in the table T. For example, for a division into 4×4 squares, the procedure is carried out 16 times, with offsets in x running from 0 to 3 and offsets in y running from 0 to 3. The final image (Im_final), estimated without noise, will be the mean of the 16 images reconstituted in this way.

This mean value can take into account the number of times each pixel of the image is really included in the processing, so as not to cause edge effects to appear. Another advantage of repetition is that it eliminates geometrical artifacts that can occur because of the division into elementary rectangles.

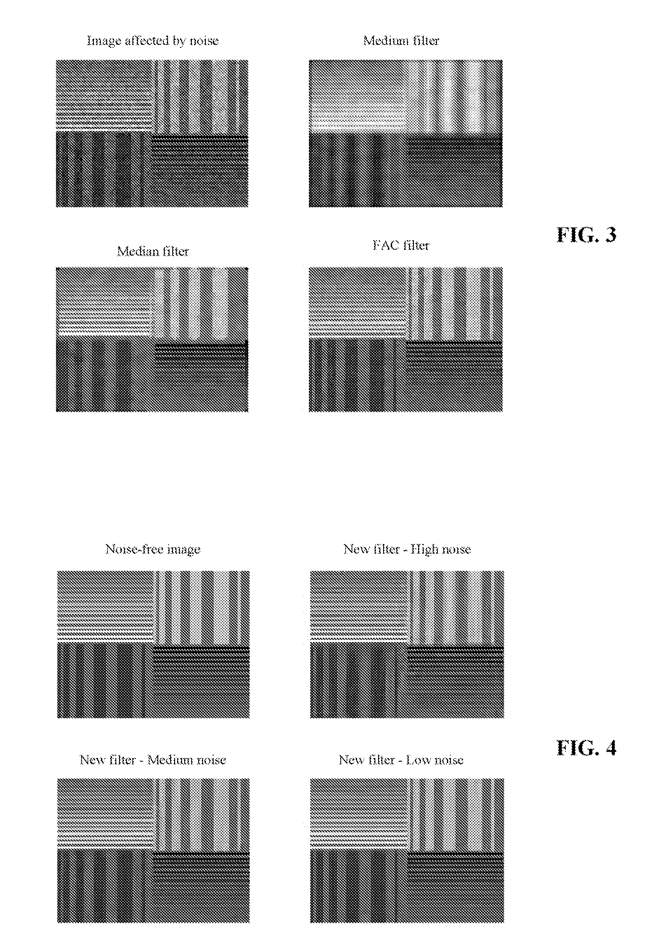

FIG. 4 shows the result of filtering in accordance with the invention for the noise-free digital phantom image (top left) and for the three images subject to noise shown in FIG. 2.

The present invention is not limited to the embodiments that have been described explicitly, but includes variants and generalizations thereof within the scope of the following claims.

1-12. (canceled)

13. Method of processing a digitized image consisting of a table T of numbers x₍ᵢⱼ₎ each expressing the degree of brightness of a corresponding pixel (i, j), the method comprising the reduction of high-frequency noise by the following steps:
a) decomposing the table T into a continuous series of p elementary tables of the same size each having n pixels,
b) ordering the data from the series of elementary tables into a processing table X of p rows and n columns, each row i being formed of the ordered series of the pixels of the elementary table of rank i,
d) effecting on the processing table X an orthogonal transformation into the frequency space, considering the n columns as variables, to extract therefrom the n representative orthogonal functions associated with their coefficients,
f) generating a reconstituted processing table XR of numbers xr_{(i,j)} by independently reconstructing each row i taking into account only the functions having a significant weight with the row i, and re-establishing the absolute degrees of brightness, then generating a reconstituted table TR constituting the reconstituted digitized image in which high-frequency noise has therefore been reduced,
wherein, during the step d), a pre-established orthogonal transformation with n pre-established orthogonal coefficients is used.

14. Method according to claim 13, wherein the step d) uses a discrete cosine transform to calculate, for each row of the processing table X, the coefficients corresponding to the n orthogonal functions.

15. Method according to claim 14, wherein:
during a step e) the squared cosines of the rows are calculated on the n orthogonal functions,
the squared cosines are used to test the weight of the representative functions in the row i.

16. Method according to claim 15, wherein:
a coefficient cₖ(i) of the row i is calculated on the function k from the formula
$${c}_{k} ( i ) = {\sum }_{j = 1}^{n} {x}_{ij} \cdot fk ( j )$$
in which fk(j) is the j^{th} value of the function fk,
the step e) calculates the squared cosine from the formula:
cos²ₖ(i)=cₖ(i)cₖ(i)

17. Method according to claim 16, wherein the reconstructed value xrᵢⱼ(q) of the element of the reconstituted processing table XR from row i and column j taking into account the q appropriate functions is calculated from the formula:
$${xr}_{ij} ( q ) = {\sum }_{k = 1}^{q} {c}_{k} ( i ) fk ( j ) .$$

18. Method according to claim 13, wherein the reconstructed values xrᵢⱼ of a row i of elements from the reconstituted table XR are calculated step by step, by successively calculating the value of the elements xrᵢⱼ of the row for q increasing values, each time calculating the residual variance of the row i (Var_res(q)), comparing it to the estimated variance of the noise to be reduced, and stopping the calculation for the row i when the residual variance of the row i is no longer statistically greater than the estimated variance of the noise of the row i in the starting image, thereby obtaining a final image (Im_final) estimated without noise.

19. Method according to claim 18, wherein the residual variance Var_res(q) of the row i is the variance of the difference between the row i of the processing table X and the row i of the reconstituted processing table XR as reconstructed with q functions.

20. Method according to claim 18, wherein the test comparing the residual variance and the estimated variance of the noise is effected by:
a) calculating the variable t from the formula
t=(Var_noise)xhi(ddl)/ddl
in which xhi (ddl) is the value given by the χ² table for a risk of 5% and a number ddl of degrees of freedom,
ddl is the number of degrees of freedom, where
ddl=n−q−1
q being the number of factors taken into account,
b) stopping the reconstruction when the residual variable Var_res(q) is less than t.

21. Method according to claim 18 applied to processing an image affected by noise conforming to a Poisson law, wherein the estimated variance of the noise of the row i is taken as equal to the mean of the elements xᵢⱼ of the row i of the processing table X.

22. Method according to claim 13, wherein the method is repeated several times on the same image, each time offsetting by one pixel the division into elementary tables, and calculating the mean value of the reconstituted images obtained in this way.

23. Device for processing digitized images, comprising a memory, a calculation unit, an input-output device for receiving data constituting the digitized image to be processed, viewing means and/or printing means for viewing the processed image, and a program stored in memory and adapted to execute the method according to claim 13.

24. Medical imaging installation comprising a device according to claim 23.
